(19) United States
(12) Patent Application Publication
(10) Pub. No.: US 2014/0156628 A1
(43) Pub. Date: Jun. 5, 2014

(54) SYSTEM AND METHOD FOR DETERMINATION OF CAUSALITY BASED ON BIG DATA ANALYSIS

(71) Applicant: CORTICA LTD., Ramat Gan (IL)

(72) Inventors: Igal Raichelgauz, Ramat Gan (IL); Karina Odinaev, Ramat Gan (IL); Yehoshua Y. Zeevi, Haifa (IL)

(73) Assignee: CORTICA LTD., Ramat Gan (IL)

(21) Appl. No.: 14/171,158

(22) Filed: Feb. 3, 2014

Related U.S. Application Data
(63) Continuation-in-part of application No. 13/602,858, filed on Sep. 4, 2012.
Application No. 13/602,858 is a continuation of application No. 12/603,123, filed on Oct. 21, 2009, now Pat. No. 8,266,185.
Application No. 12/603,123 is a continuation-in-part of application No. 12/084,150, filed on Apr. 7, 2009, now Pat. No. 8,655,801.
Application No. 12/603,123 is a continuation-in-part of application No. 12/195,863, filed on Aug. 21, 2008, now Pat. No. 8,326,775.
Application No. 12/195,863 is a continuation-in-part of application No. 12/084,150, filed on Apr. 7, 2009, now Pat. No. 8,655,801.
Application No. 12/603,123 is a continuation-in-part of application No. 12/348,888, filed on Jan. 5, 2009.
Application No. 12/348,888 is a continuation-in-part of application No. 12/084,150, filed on Apr. 7, 2009, now Pat. No. 8,655,801.
Application No. 12/084,150 is a continuation-in-part of application No. 12/195,863, filed on Aug. 21, 2008, now Pat. No. 8,326,775.
Application No. 12/603,123 is a continuation-in-part of application No. 12/538,495, filed on Aug. 10, 2009, now Pat. No. 8,312,031.
Application No. 12/538,495 is a continuation-in-part of application No. 12/084,150, filed on Apr. 7, 2009, now Pat. No. 8,655,801.
Application No. 12/084,150 is a continuation-in-part of application No. 12/195,863, filed on Aug. 21, 2008, now Pat. No. 8,326,775.
Application No. 12/195,863 is a continuation-in-part of application No. 12/348,888, filed on Jan. 5, 2009.
(60) Provisional application No. 61/763,501, filed on Feb. 12, 2013.

(30) Foreign Application Priority Data
Oct. 26, 2005 (IL) 171577
Jan. 29, 2006 (IL) 173409
Aug. 21, 2007 (IL) 185414

(51) Int. Cl. G06F 17/30

(52) U.S. Cl. CPC G06F 17/30722; G06F 17/30705; G06F 17/30864
USPC 707/709; 707/758; 707/737; 707/723

(57) ABSTRACT

A method and system for determining causality based on big data analysis are provided. The method comprises extracting a plurality of unstructured data elements from a plurality of unstructured big data sources; generating at least one signature for each of the plurality of unstructured data elements; identifying at least one common pattern within the signatures of the plurality of unstructured data elements; matching the at least one common pattern to at least one hypothesis by comparing at least one signature of the common pattern to at least one hypothesis; and determining the causality of the at least one common pattern based on the at least one hypothesis matching the at least one common pattern.

### CROSS-REFERENCE TO RELATED APPLICATIONS

This application claims the benefit of U.S. provisional application 61/763,501 filed on Feb. 12, 2013. This application is a continuation-in-part (CIP) of U.S. patent application Ser. No. 13/602,858 filed Sep. 4, 2012, which is a continuation of U.S. patent application Ser. No. 12/603,123, filed on Oct. 21, 2009, now issued as U.S. Pat. No. 8,266,185. The Ser. No. 12/603,123 application is a CIP of:

(1) U.S. patent application Ser. No. 12/084,150 having a filing date of Apr. 7, 2009, now allowed, which is the National Stage of International Application No. PCT/IL2006/001235, filed on Oct. 26, 2006, which claims foreign priority from Israeli Application No. 171577 filed on Oct. 26, 2005 and Israeli Application No. 173409 filed on 29 Jan. 2006;

(2) U.S. patent application Ser. No. 12/195,863, filed Aug. 21, 2008, now U.S. Pat. No. 8,326,775, which claims priority under 35 USC 119 from Israeli Application No. 185414, filed on Aug. 21, 2007, and which is also a continuation-in-part of the above-referenced U.S. patent application Ser. No. 12/084,150;

(3) U.S. patent application Ser. No. 12/348,888, filed Jan. 5, 2009, now pending, which is a CIP of U.S. patent application Ser. No. 12/084,150, having a filing date of Apr. 7, 2009, now allowed, and U.S. patent application Ser. No. 12/195,863 filed on Aug. 21, 2008; and

(4) U.S. patent application Ser. No. 12/538,495, filed Aug. 10, 2009, now U.S. Pat. No. 8,312,031, which is a CIP of U.S. patent application Ser. No. 12/084,150 having a filing date of Apr. 7, 2009, U.S. patent application Ser. No. 12/195,863, filed on Aug. 21, 2008; and U.S. patent application Ser. No. 12/348,888, filed Jan. 5, 2009.

All of the applications referenced above are herein incorporated by reference for all that they contain.

### TECHNICAL FIELD

The present invention relates generally to the analysis of multimedia content, and more specifically to a system for determining the causality of incidents based on big data analysis.

### BACKGROUND

With the abundance of multimedia data made available through various means in general and the Internet and the world-wide web (WWW) in particular, there is also a need to provide effective ways of analyzing such multimedia content which is basically considered unstructured data. Unstructured data analysis is a challenging task, as it requires processing of big data. Big data typically refers to a collection of data sets that are large, complex, and cannot be analyzed using on-hand database management tools or traditional data processing applications. Furthermore, multimedia content may be complex and not necessarily adequately documented as metadata.

Several prior art solutions are used to analyze and search through such big data sources, wherein relevant data elements may be extracted from such big data sources. However, even though several determined data elements may be extracted from such big data sources as a result of a search and analysis, a problem occurs while trying to determine the attribution of the occurrences of such data elements. Typically, the complexity of the data while analyzing the characteristics of big data leads to inefficient identification of common patterns. Furthermore, the search as known today may be inefficient because of lack of correlation between data elements extracted from big data sources. As a result, the causality of an event based on correlation between pieces of information extracted from big data sources cannot be determined.

It would therefore be advantageous to provide a solution that overcomes the deficiencies of the prior art by efficiently analyzing big data. It would be further advantageous if such solution will be capable of determining the causality of data elements extracted from big data.

### SUMMARY

Certain embodiments disclosed herein include a method and system for determining causality based on big data analysis. The method comprises extracting a plurality of unstructured data elements from a plurality of unstructured big data sources; generating at least one signature for each of the plurality of unstructured data elements; identifying at least one common pattern within the signatures of the plurality of unstructured data elements; matching the at least one common pattern to at least one hypothesis by comparing at least one signature of the common pattern to at least one hypothesis; and determining the causality of the at least one common pattern based on the at least one hypothesis matching the at least one common pattern.

Certain embodiments disclosed herein include a method and system for determining a probability of a hypothesis based on big data analysis. The method comprises receiving a request to check the probability of a hypothesis a hypothesizes; generating at least one signature to the hypotheses; crawling through a plurality of relevant big data sources to detect unstructured data elements; generating at least one signature for each detected unstructured data element; and determining the probability of the hypothesis respective of the generated signatures.

### BRIEF DESCRIPTION OF THE DRAWINGS

The subject matter disclosed herein is particularly pointed out and distinctly claimed in the claims at the conclusion of the specification. The foregoing and other objects, features, and advantages of the invention will be apparent from the following detailed description taken in conjunction with the accompanying drawings.

FIG. 1 is a schematic block diagram of a network system utilized to describe the various embodiments disclosed herein.

FIG. 2 is a flowchart describing the process of determining the causality of incidents based on big data analysis according to an embodiment.

FIG. 3 is a block diagram depicting the basic flow of information in the signature generator system.

FIG. 4 is a diagram showing the flow of patches generation, response vector generation, and signature generation in a large-scale speech-to-text system.

FIG. 5 is a flowchart describing the process of determining a probability of a hypothesis based on big data analysis according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed inventions. Moreover, some statements may apply to some inventive features but not to others. In general, unless otherwise indicated, singular elements may be in plural and vice versa with no loss of generality. In the drawings, like numerals refer to like parts through several views.

Certain exemplary embodiments disclosed herein allow the determination of the causality of an incident based on an analysis of unstructured data. Unstructured data refers to information that does not have a predefined structure and is usually not organized in a consistent and predictable manner. The data tends to be recorded in free text form with little or no metadata codified into fields. Unstructured data may be, for example, a multimedia content, a book, a document, metadata, health records, audio, video, analog data, files, unstructured text, a web page, a combination thereof, a portion thereof, etc. Based on the analysis results, one or more matching signatures are generated and matched to a database in order to at least determine causality of an incident.

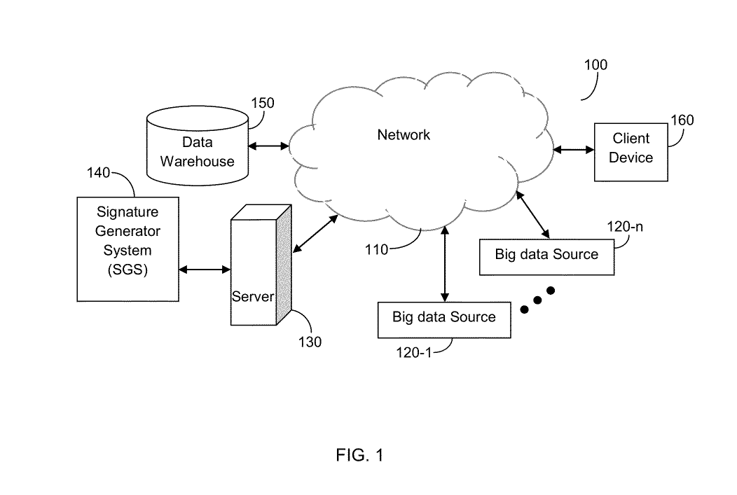

FIG. 1 shows an exemplary and non-limiting schematic diagram of a network system 100 utilized for describing the various embodiments for analyzing multimedia content and determines common patterns of unstructured data elements extracted from big data sources. A network 110 is used to communicate between different parts of the system 100. The network 110 may be the Internet, the world-wide-web (WWW), a local area network (LAN), a wide area network (WAN), a metro area network (MAN), and other networks for enabling communication between the elements of the system 100.

A server 130 is connected to the network 110. The server 130 is configured to correlate between unstructured data elements extracted from big data sources comprising unstructured data as described in detail below. The server 130 typically comprises a processing unit, such as a processor (not shown) that is communicatively connected to a memory (not shown). The memory contains instructions that are executed by the processor. The server 130 also includes an interface (not shown) to the network 110.

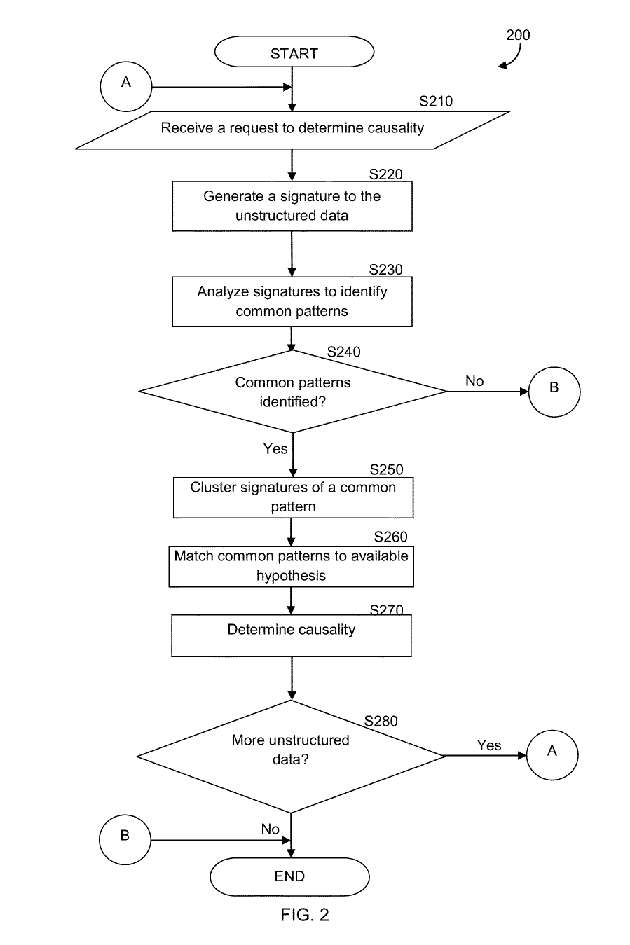

In one embodiment, a database such as a data warehouse 150 is connected to the server 130 (either directly or through the network 110). The server 130 is configured to store information identified and/or generated by the server 130 for further use in the data warehouse 150. Such information may include, signatures generated for the unstructured data elements, common patterns identified between the unstructured data elements, common concepts identified between the common patterns, and so on, as described in greater detail with respect of FIG. 2.

Further connected to the network 110 are a plurality of big data sources 120-1 through 120-n, each of which may contain, store, or generate unstructured data. The big data sources 120-1 through 120-n are accessible by the server 130 through the network 110. The system 100 also includes a signature generator system (SGS) 140. In one embodiment, the SGS 140 is connected to the server 130. The server 130 is configured to receive and serve the unstructured data elements. Moreover, the server 130 is configured to cause the SGS 140 to generate the signatures respective of the unstructured data elements. Each signature is generated for each element of the unstructured data.

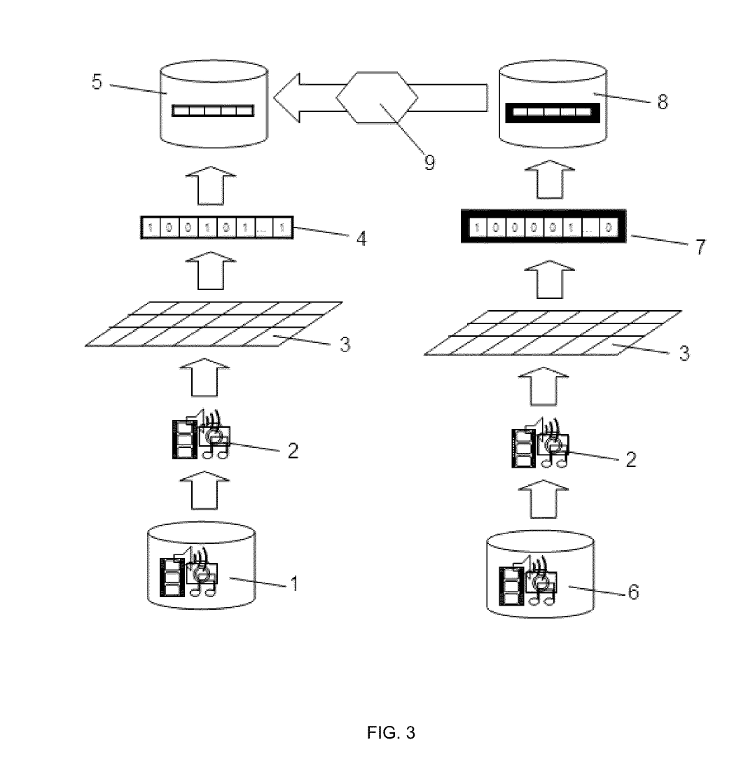

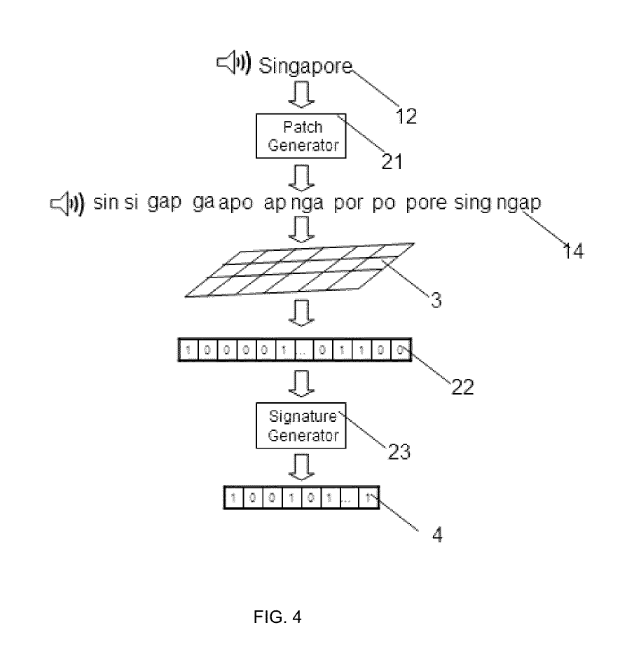

The SGS 140 typically comprises a processing unit and a memory maintaining executable instructions. Such instructions may be executed by the processor. The process for generating the signatures for the unstructured data elements, is explained in more detail herein below with respect to FIGS. 3 and 4.

According to the embodiments disclosed herein, unstructured data stored in the big data sources 120 or provided by a client device 160 are processed and analyzed by the server 130 to determine the causality. The unstructured data can be generated and sent by a script executed in the web-page, or by an agent installed in the web-browser of the client device 150. In an embodiment, the client device 150 queries the server 130 for the required data analysis. In an embodiment, the unstructured data may include multimedia content elements extracted from the web-page. A multimedia content element may include, for example, an image, a graphic, a video stream, a video clip, an audio stream, an audio clip, a video frame, a photograph, and an image of signals (e.g., spectrograms, phasograms, scalograms, etc.), and/or combinations thereof and portions thereof. The content elements may be extracted from a web-page provided by the client device. The query of the server 130 to determine the causality between two events, phenomena, etc. can be, for example, a sole free text query, or a free text query submitted with content element(s) to be analyzed. For example, the input multimedia content element(s) is a chest X-ray (which is unstructured data) with a text query Pneumonia. The server 130, upon reception of such query and multimedia content element, determines the causality of Pneumonia in other chest X-rays having similar characteristics as the input X-ray. This causality may be determined to be the appearance of opaque (i.e., white) spots appearing on the X-ray, as such spots commonly appear on X-rays of patients with Pneumonia. The other chest X-rays required for processing are retrieved from the data sources 120.

According to the disclosed embodiments, at least one signature is generated for each unstructured data item being analyzed by the server 130. The signatures are generated by the SGS 140 and are robust to noise and distribution as discussed below. Then, using the generated signatures, the server 130 searches for common patterns through the signatures. Upon identification of one or more common pattern through the signatures, the server 130 matches the common pattern to one or more hypotheses available in the data warehouse 150 in order to determine the causality. In another embodiment, the selected patterns are matched to one or more hypotheses extracted from the unstructured data itself. It should be noted that using signatures for determining causalities ensures more accurate reorganization of causalities, for example, when using metadata.

In one embodiment, the signatures generated for more than one unstructured data item are clustered. The clustered signatures are used to search for a common concept of the unstructured data elements. The concept is a collection of signatures representing elements of the unstructured data and metadata describing the concept. As a non-limiting example, a ‘Superman concept’ is a signature reduced cluster of signatures describing elements (such as multimedia elements) related to, e.g., a Superman cartoon: a set of metadata representing proving textual representation of the Superman concept. Techniques for generating concepts and concept structures are also described in the co-pending U.S. patent application Ser. No. 12/603,123 (hereinafter the '123 Application) to Raichelgauz et al., which is assigned to common assignee, and is incorporated hereby by reference for all that it contains.

FIG. 2 depicts an exemplary and non-limiting flowchart 200 describing the process of determining the causality of incidents based on big data analysis according to an embodiment. In an embodiment, the process discussed with reference to FIG. 2 is performed by the server 130 when the signatures are generated by means of the SGS 140.

In S210, a request to determine the causality respective of at least one unstructured data item is received. The request may also include a text query related to the event of the causality to be determined. As noted above, the unstructured data item may be, for example, a multimedia content, a book, a document, metadata, health records, audio, video, analog data, files, unstructured text, web pages, a combination thereof, a portion thereof, and so on. Alternatively or collectively, unstructured data elements retrieved from a plurality of big data sources, e.g. sources 120-1, 120-n. The sources may be classified by the data contained therein. For example, big data sources 120-1, 120-n may be related to all images found on the Internet, diagnostic information of a large group of patients, sales information of a large group of retail stores, and so on. The retrieval of unstructured data elements may be sources that contain information related to the effect and/or items included in the request. Retrieval of unstructured data elements may be also required to provide sufficient data set for processing.

In S220, at least one signature is generated for each of the input unstructured data items. The signatures for the unstructured data items are generated by the SGS 140 as described below.

In S230, the generated signatures are analyzed to identify common patterns among the generated signatures. In one embodiment, a process of inter-matching is performed on the generated signatures. In an exemplary embodiment, this process includes matching signatures of all the extracted elements to each other. Each match of two signatures is assigned with a matching score being compared to a preconfigured threshold. When the matching score exceeds the preconfigured threshold, the two signatures are determined to have common pattern.

In S240, it is checked whether at least one common pattern is identified through the generated signatures and if so, execution continues with S250; otherwise, execution terminates.

In S250, the signatures determined to have a common pattern are clustered. In an embodiment, the clustering of the signatures is discussed in detail in the co-pending U.S. patent application Ser. No. 12/507,489, entitled “Unsupervised Clustering of Multimedia Data Using a Large-Scale Matching System,” filed Jul. 22, 2009, assigned to common assignee, and which is hereby incorporated for all that it contains. It should be noted that S240 and S250 can result in a plurality of different clusters. A cluster, and hence a common pattern is represented by a signature. As noted above, a cluster of a common pattern may include a textual metadata.

As a non-limiting example, several sales reports of worldwide retail chain stores are received by the server 130. The reports are analyzed and signatures are generated respective of each element within the reports. An element within the reports may be, for example, a certain product, or a certain product together with the quantity sold. Respective of the generated signatures, common patterns are identified, and then clustered as described above. For example, a first common pattern of a first cluster of signatures indicates that every certain date a significant amount of products which are packed in red packages are being sold. A second common pattern of second cluster of signatures indicates that an extensive amount of jewelry is sold in February. A third common pattern of a third cluster of signatures indicates an increase in sales of alcoholic beverages on the eve of February 14^{th}.

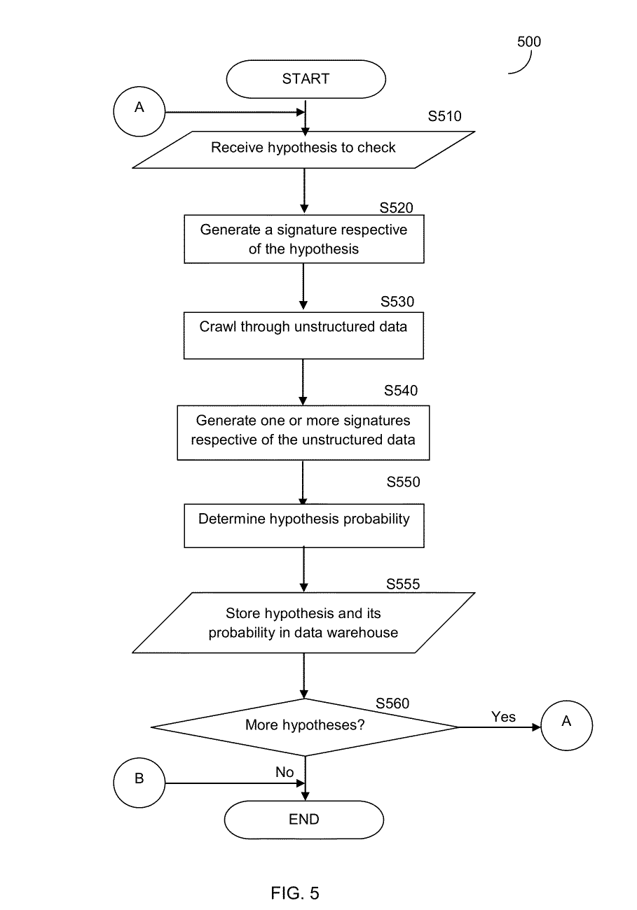

In S260, the common pattern is matched to one or more hypotheses available in the data warehouse 150. A hypothesis is a textual content that represents a series of natural events. Each event in the hypothesis leads to the following event and the last event is considered to be the result of the hypothesis. As a hypothesis is a textual content at least one signature can be generated thereof. The at least one signature for the hypothesis is generated by the SGS 140. As will be described below with reference to FIG. 5 hypotheses are saved in the data warehouse together with their respective signatures.

In an embodiment, the hypotheses utilized in the matching in S260 are selected from the data warehouse 150 based on the text query provided in S210 or the event specified therein. The signature matching process is described in more detail with respect to FIG. 4. In an exemplary embodiment, when two signatures overlap more than a predetermined threshold level, for example 60% of the signature match, these signatures may be considered as matching. In another embodiment, a hypothesis may be compared to elements extracted from common pattern per the matching of signatures among common patterns and a matching score may be assigned to each match. In an exemplary embodiment, if the matching score of a hypothesis to the common pattern exceeds a preconfigured threshold, the hypothesis is determined to match the common pattern or condition.

In S270, the causality based on the matching between the common pattern and the one or more hypotheses are determined. In one embodiment, S260 includes correlating hypotheses that match the common pattern. The correlation refers to any of a broad class of statistical relationships involving at least two sets of data. In an embodiment, probability values representing the likelihood that a hypothesis is the causation of a certain event or condition may be calculated. In the embodiment, the probability value associated with each hypothesis may be compared against the probability values of other hypotheses to determine which hypothesis is associated with the largest probability value. Accordingly, in that embodiment, the causality may be determined to be the hypothesis associated with the largest probability value. The probability value associated with a hypothesis may be a function of the respective matching to the common pattern. For example, a hypothesis with 90% matching signature will have a higher probability then a hypothesis with 63% matching signature.

In S280, it is checked whether additional unstructured data elements received, and if so, execution continues with S210; otherwise, execution terminates.

As a non-limiting example, several daily newspapers are uploaded. The newspapers are analyzed and signatures are generated respective thereto. Respective of the newspapers' signatures, a common pattern is identified, indicating that several traffic accidents occurred during the first week of January in mid-Manhattan. This common pattern is then matched to one or more hypotheses available. According to this embodiment, a first hypothesis available is that alcohol increases the risk for vehicle crashes for all drivers. A second hypothesis available is that extensive amount of bars and liquor stores are located in mid-Manhattan. A third hypothesis available is that young population commonly drinks alcohol at New Year's Eve. In the example, all these hypotheses are determined to match a signature of the identified. Further, a matching score is determined for each of the hypotheses and each of the matching scores is compared to a preconfigured threshold. As an example, only the first hypothesis, that alcohol increases the risk of crashing a vehicle, exceeds the preconfigured threshold. It is therefore determined that the causality of the traffic accidents occurred during the first week of January in mid-Manhattan is due to drunk drivers.

FIGS. 3 and 4 illustrate the generation of signatures for the multimedia content elements by the SGS 140 according to one embodiment. An exemplary high-level description of the process for large scale matching is depicted in FIG. 3. In this example, the matching is for a video content.

Video content segments 2 from a Master database (DB) 6 and a Target DB 1 are processed in parallel by a large number of independent computational Cores 3 that constitute an architecture for generating the Signatures (hereinafter the “Architecture”). Further details on the computational Cores generation are provided below. The independent Cores 3 generate a database of Robust Signatures and Signatures 4 for Target content-segments 5 and a database of Robust Signatures and Signatures 7 for Master content-segments 8. An exemplary and non-limiting process of signature generation for an audio component is shown in detail in FIG. 4. Finally, Target Robust Signatures and/or Signatures are effectively matched, by a matching algorithm 9, to Master Robust Signatures and/or Signatures database to find all matches between the two databases.

To demonstrate an example of signature generation process, it is assumed, merely for the sake of simplicity and without limitation on the generality of the disclosed embodiments, that the signatures are based on a single frame, leading to certain simplification of the computational cores generation. The Matching System is extensible for signatures generation capturing the dynamics in-between the frames.

The Signatures' generation process will now be described with reference to FIG. 4. The first step in the process of signatures generation from a given speech-segment is to breakdown the speech-segment to K patches 14 of random length P and random position within the speech segment 12. The breakdown is performed by the patch generator component 21. The value of the number of patches K, random length P and random position parameters is determined based on optimization, considering the tradeoff between accuracy rate and the number of fast matches required in the flow process of the server 130 and SGS 140. Thereafter, all the K patches are injected in parallel into all computational Cores 3 to generate K response vectors 22, which are fed into a signature generator system 23 to produce a database of Robust Signatures and Signatures 4.

In order to generate Robust Signatures, i.e., Signatures that are robust to additive noise L (where L is an integer equal to or greater than 1) by the Computational Cores 3 a frame ‘i’ is injected into all the Cores 3. Then, Cores 3 generate two binary response vectors: \vec{S} which is a Signature vector, and \vec{RS} which is a Robust Signature vector.

For generation of signatures robust to additive noise, such as White-Gaussian-Noise, scratch, etc., but not robust to distortions, such as crop, shift and rotation, etc., a core Cᵢ={nᵢ} (1≦i≦L) may consist of a single leaky integrate-to-threshold unit (LTU) node or more nodes. The node nᵢ equations are:

$${V}_{i} = {\sum }_{j} {w}_{ij} {k}_{j}$$

$${n}_{i} = • ( Vi - {Th}_{x} )$$

where, □ is a Heaviside step function; wᵢⱼ is a coupling node unit (CNU) between node i and image component j (for example, grayscale value of a certain pixel j); kⱼ is an image component ‘j’ (for example, grayscale value of a certain pixel j); Thx is a constant Threshold value, where x is ‘S’ for Signature and ‘RS’ for Robust Signature; and Vi is a Coupling Node Value.

The Threshold values Thx are set differently for Signature generation and for Robust Signature generation. For example, for a certain distribution of Vi values (for the set of nodes), the thresholds for Signature (Th_{S}) and Robust Signature (Th_{RS}) are set apart, after optimization, according to at least one or more of the following criteria:
1: For: Vᵢ>Th_{RS}
   1−p(V>Th_{S})−1−(1−ε)^{l}<<1

i.e., given that l nodes (cores) constitute a Robust Signature of a certain image I, the probability that not all of these l nodes will belong to the Signature of same, but noisy image, \tilde{•} is sufficiently low (according to a system's specified accuracy).
2: p(Vᵢ>Th_{RS})≈l/L
   i.e., approximately l out of the total L nodes can be found to generate a Robust Signature according to the above definition.
3: Both Robust Signature and Signature are generated for certain frame i.

It should be understood that the generation of a signature is unidirectional, and typically yields lossless compression, where the characteristics of the compressed data are maintained but the uncompressed data cannot be reconstructed. Therefore, a signature can be used for the purpose of comparison to another signature without the need of comparison to the original data. Detailed description of the Signature generation can be found U.S. Pat. Nos. 8,326,775 and 8,312,031, assigned to common assignee, which are hereby incorporated by reference for all the useful information they contain.

A Computational Core generation is a process of definition, selection, and tuning of the parameters of the cores for a certain realization in a specific system and application. The process is based on several design considerations, such as:

(a) The Cores should be designed so as to obtain maximal independence, i.e., the projection from a signal space should generate a maximal pair-wise distance between any two cores' projections into a high-dimensional space.

(b) The Cores should be optimally designed for the type of signals, i.e., the Cores should be maximally sensitive to the spatio-temporal structure of the injected signal, for example, and in particular, sensitive to local correlations in time and space. Thus, in some cases a core represents a dynamic system, such as in state space, phase space, edge of chaos, etc., which is uniquely used herein to exploit their maximal computational power.

(c) The Cores should be optimally designed with regard to invariance to a set of signal distortions, of interest in relevant applications. Detailed description of the Computational Core generation, the computational architecture, and the process for configuring such cores is discussed in more detail in the co-pending U.S. patent application Ser. No. 12/084,150 referenced above.

FIG. 5 depicts an exemplary and non-limiting flowchart 500 describing the process of determining a hypothesis probability based on big data analysis according to an embodiment. The method may be performed by the server 130 using the SGS 140.

In S510, a request to check a hypothesis probability is received. As noted above, a hypothesis is a textual content that represents a series of natural events. Each event in the hypothesis leads to the following event and the last event is considered to be the result of the hypothesis. In S520, at least one signature is generated for the hypothesis. The generated signature(s) may be robust to noise and distortion. In S530, the server 130 crawls through relevant unstructured data stored in big data sources 120-1 through 120-n. The relevancy of an unstructured data is determined by the server 130 based on the signature of hypothesis.

According to another embodiment, the relevant unstructured data is provided together with the request to check the probability of the hypothesis.

In S540, one or more signatures are generated for the relevant unstructured data elements within the big data.

In S550, respective of the signatures of the hypothesis and the one or more signatures of the relevant unstructured data, the probability of the hypothesis is computed. In one embodiment, the probability is computed based on the matching of a signature of a hypothesis to a signature of the relevant unstructured data. The percentage of overlap between the two signatures is the probability. For example, if the signature matching is 95%, the hypothesis' probability is 0.95. In another embodiment, the probability is determined based on a matching score of each hypothesis to unstructured data. As a non-limiting example of probability values based on the matching score of each hypothesis to a signature of the unstructured data, matching scores may be based on a scale from 0 to 10. For example, for unstructured data related to sales of movie theater tickets where sales increase significantly during the months June, July, and August, the hypotheses “students have time off from school during summer,” “more movies are released during summer than during other seasons,” and “popular movie franchises are more likely to be released in summer than in other seasons” may have matching scores of 4, 5, and 6, respectively. These matching scores may correspond, for example, with probabilities of 40%, 50%, and 60%, respectively.

In S555, the hypothesis and its determined probability are stored in the data warehouse 160 for further use. In S560, it is checked whether additional requests to check hypotheses have been received and, if so, execution continues with S510; otherwise, execution terminates.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the principles of the invention and the concepts contributed by the inventor to furthering the art, and are to be construed as being without limitation to such specifically recited examples and conditions. Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

What is claimed is:

1. A method for determining causality based on big data analysis, comprising:
extracting a plurality of unstructured data elements from a plurality of unstructured big data sources;
generating at least one signature for each of the plurality of unstructured data elements;
identifying at least one common pattern within the signatures of the plurality of unstructured data elements;
matching the at least one common pattern to at least one hypothesis by comparing at least one signature of the common pattern to at least one hypothesis; and
determining the causality of the at least one common pattern based on the at least one hypothesis matching the at least one common pattern.

2. The method of claim 1, further comprising:
generating the at least one signature for the at least one hypothesis.

3. The method of claim 1, wherein identifying the at least one common pattern further comprises:
clustering the signatures identified to have common patterns; and
correlating the generated clusters to identify associations between their respective identified common patterns.

4. The method of claim 1, wherein determining the causality further comprises:
correlating the at least one hypothesis matching the at least one common pattern.

5. The method of claim 1, wherein determining the causality further comprises:
computing a matching score based on the comparisons of the signatures;
determining a hypothesis having the highest matching score to be the causality.

6. The method of claim 1, wherein the at least one hypothesis is textual content representing a series of natural events, wherein the at least one hypothesis is extracted from big data sources.

7. The method of claim 1, wherein the unstructured data element is at least one of: multimedia content, a document, metadata, a collection of health records, analog data, a file, unstructured text, and a web page.

8. The method of claim 7, wherein the multimedia content element is at least one of: an image, graphics, a video stream, a video clip, an audio stream, an audio clip, a video frame, a photograph, images of signals, combinations thereof, and portions thereof.

9. A non-transitory computer readable medium having stored thereon instructions for causing one or more processing units to execute the method according to claim 1.

10. A system for determination of a causality based on big data analysis, comprising:
an interface to a network for connecting to a plurality of big data sources;
a processor;
a memory connected to the processor, the memory contains instructions that when executed by the processor, configure the system to:
extract a plurality of unstructured data elements from a plurality of unstructured big data sources;
generate at least one signature for each of the plurality of unstructured data elements;
identify at least one common pattern within the signatures of the plurality of unstructured data elements;
match the at least one common pattern to at least one hypothesis by comparing at least one signature of the common pattern to at least one hypothesis; and
determine the causality of the at least one common pattern based on the at least one hypothesis matching the at least one common pattern.

11. The system of claim 10, wherein the system is further configured to:
generate the at least one signature for the at least one hypothesis.

12. The system of claim 10, wherein the system is further configured to:
cluster the signatures identified to have common patterns; and
correlate the generated clusters to identify associations between their respective identified common patterns.

13. The system of claim 10, wherein the system is further configured to:
correlate the at least one hypothesis matching the at least one common pattern.

14. The system of claim 10, wherein the system is further configured to:
compute a matching score based on the comparisons of the signatures;
determine a hypothesis having the highest matching score to be the causality.

15. The system of claim 10, wherein the at least one hypothesis is textual content representing a series of natural events, wherein the at least one hypothesis is extracted from big data sources.

16. The system of claim 10, wherein the unstructured data element is at least one of: multimedia content, a document, metadata, a collection of health records, analog data, a file, unstructured text, and a web page.

17. The system of claim 16, wherein the multimedia content element is at least one of: an image, graphics, a video stream, a video clip, an audio stream, an audio clip, a video frame, a photograph, images of signals, combinations thereof, and portions thereof.

18. The system of claim 10, further comprising a database for storing the determined causality.

19. A method for determining a probability of a hypothesis based on big data analysis, comprising:
receiving a request to check the probability of a hypothesis a hypothesizes;
generating at least one signature to the hypotheses;
crawling through a plurality of relevant big data sources to detect unstructured data elements;
generating at least one signature for each detected unstructured data element; and
determining the probability of the hypothesis respective of the generated signatures.

20. The method of claim 19, further comprising:
matching the at least one signature of the unstructured data element to the at least one generated for of the hypothesis; and
computing the probability based on the matching results.

21. A non-transitory computer readable medium having stored thereon instructions for causing one or more processing units to execute the method according to claim 13.
